(19) United States
(12) Patent Application Publication
(10) Pub. No.: US 2025/0045353 A1
(43) Pub. Date: Feb. 6, 2025

(54) Secant line approximation method for nonlinear constraint of redundant drive system

(71) Applicant: SHANDONG JIAOTONG UNIVERSITY, Jinan (CN)

(72) Inventors: Jiuhong Ruan, Jinan (CN); Yuhong Xing, Jinan (CN)

(21) Appl. No.: 18/630,016

(22) Filed: Apr. 9, 2024

(30) Foreign Application Priority Data
Apr. 10, 2023 (CN) 202310369387.7

(51) Int. Cl. G06F 17/17

(52) U.S. Cl. CPC G06F 17/17

(57) ABSTRACT

Provided is a secant line approximation method for a nonlinear constraint of a redundant drive system, which relates to the technical field of dynamics control allocation of the redundant drive system. The method includes: first obtaining, based on a control input model for a redundant drive system with any pair of nonlinear constraint components, a closed region of the model that is formed by intersecting a rectangle and an ellipse on a geometric plane; and after dividing the closed region into a union set of rectangles and elliptical triangles, approximating the elliptical triangle based on a combination of rectangles and triangles to obtain an approximation result of the closed region, thereby achieving a linear approximation of the pair of nonlinear constraint components.

### CROSS REFERENCE TO RELATED APPLICATION

This patent application claims the benefit and priority of Chinese Patent Application No. 202310369387.7 filed with the China National Intellectual Property Administration on Apr. 10, 2023, the disclosure of which is incorporated by reference herein in its entirety as part of the present application.

### TECHNICAL FIELD

The present disclosure relates to the technical field of dynamics control allocation of a redundant drive system, and specifically, to a secant line approximation method for a nonlinear constraint of a redundant drive system.

### BACKGROUND

Control allocation is responsible for allocating an expected system control vector to each redundant actuator for execution. A direct allocation method based on a control attainable set is an important method for the control allocation. Calculation of the control attainable set is to determine, in the case of a known variation range of each actuator, a boundary of a system control attainable vector that can be achieved by all actuators acting simultaneously, to obtain a control capability of a redundant drive system. The direct allocation method is based on the calculation of the control attainable set.

A control attainable set of a parallel hybrid redundant drive system can be mathematically expressed as follows:

$$Φ = \{ v \vert v = B \cdot u , u ∈ Ω \} \qquad ( 1 - 1 )$$

In the expression (1-1), u represents a control vector, which represents a control input of the redundant drive system, and u=(u₁, . . . , uₘ)^{T}, where T represents a matrix transpose symbol, and an i^{th} control component uᵢ is a control action of a corresponding i^{th} actuator, where 1≤i≤m, m represents a quantity of actuators, uᵢₘᵢₙ≤uᵢ≤uᵢₘₐₓ, uᵢₘᵢₙ represents a minimum control action of the i^{th} actuator, and uᵢₘₐₓ represents a maximum control action of the i^{th} actuator; there is often a linear or nonlinear constraint between each uᵢ; Ω represents a control set, and Ω={u}; v represents a control attainable vector of the redundant drive system, and v=(v₁, . . . , vₘ)^{T}, which represents a control output of the redundant drive system, where vⱼ represents a j^{th} control attainable component, 1≤j≤n, n represents a dimension of the control attainable vector, and n<m; Φ represents the control attainable set; and B represents a n-row and m-column control efficiency matrix.

The above expression (1-1) is physically used to describe how to determine, based on the control efficiency matrix B, the control attainable vector set Φ composed of n control outputs, provided that the control vector set Q composed of m control inputs of the redundant drive system is known.

The patent “Method for Determining Control Attainable Set of Redundant Drive System under a Plurality of Linear Constraint Control Component Pairs” (Patent No. ZL201911405939.5) solves a problem of determining the control attainable set when there is a linear constraint relationship between control actions of a plurality of actuator pairs.

However, for a redundant drive system with a nonlinear constraint relationship between actuators, such as a four-wheel independently driven, independently braked, and independently steered vehicle, there is currently no effective method for determining a control attainable set of the redundant drive system.

For such a control set formed by a control vector with a nonlinear constraint, problem difficulty can be effectively reduced by approximating the nonlinear constraint, transforming a nonlinear inequality constraint into a plurality of linear constraints, transforming a nonlinear problem into a linear problem, and then calculating the control attainable set by using a mature method.

### SUMMARY

An objective of the present disclosure is to provide a secant line approximation method for a nonlinear constraint of a redundant drive system to overcome the shortcomings in the existing technologies. The present disclosure solves a linear approximation problem in a redundant drive system where a geometric figure formed by a nonlinear constraint can be divided into a combination of a rectangle and an elliptical triangle. The triangle and the rectangle can be used together to approximate a region enclosed by the nonlinear constraint to transform the nonlinear constraint into a plurality of linear constraints and transform a nonlinear constraint set into a linear constraint set. This can effectively solve a problem that a control attainable set of the redundant drive system cannot be determined due to a nonlinear constraint relationship between actuators in the redundant drive system, which is conducive to achieving real-time control of the redundant drive system.

The present disclosure provides a secant line approximation method for a nonlinear constraint of a redundant drive system, including:
step 1: constructing a control input model for a redundant drive system with any pair of nonlinear constraint components, and obtaining a corresponding closed region of the model that is formed by intersecting a rectangle and an ellipse on a geometric plane, where
the control input model for the redundant drive system with the pair of nonlinear constraint components is expressed as follows:

$$\{ \begin{matrix}\frac{{u}_{1}^{2}}{{a}^{2}} + \frac{{u}_{2}^{2}}{{b}^{2}} \leq 1 \\ {u}_{1 min} \leq {u}_{1} \leq {u}_{1 max} \\ {u}_{2 min} \leq {u}_{2} \leq {u}_{2 max}\end{matrix} \qquad ( 1 )$$

where u₁ and u₂ respectively represent two control actions in the pair of nonlinear constraint components, −a≤u₁≤a represents a corresponding range of the control action u₁, −b≤u₂≤b represents a corresponding range of the control action u₂, uᵢₘᵢₙ represents a minimum value of a current control action of an i^{th} actuator, uᵢₘₐₓ represents a maximum value of the current control action of the i^{th} actuator, i=1,2, −a≤u₁ₘᵢₙ<u₁ₘₐₓ≤a, and −b≤u₂ₘᵢₙ<u₂ₘₐₓ≤b; and
in the closed region, lengths of a semi-major axis and a semi-minor axis of the ellipse are a and b respectively; and a length and a width of the rectangle are u₁ₘₐₓ-u₁ₘᵢₙ and u₂ₘₐₓ-u₂ₘᵢₙ respectively;
step 2: based on the closed region obtained in step 1, separately drawing a perpendicular line from an intersection between the rectangle and the ellipse towards a major axis and a minor axis of the ellipse, dividing the closed region into a union set of rectangles and elliptical triangles, and placing the rectangles in the union set into an initially empty set W and the elliptical triangles into an initially empty set Y;
where each elliptical triangle is a figure enclosed by two right-angle sides of a right triangle and an elliptical arc connecting two vertices of a hypotenuse of the right triangle;
step 3: approximating, based on a combination of rectangles and triangles, an elliptical triangle obtained in step 2, where specific steps are as follows:
step 3-1: selecting any elliptical triangle in the set Y, and denoting the elliptical triangle as M₁P₁N where an intersection between two right-angle sides of the elliptical triangle is M₁, an endpoint of a right-angle side perpendicular to the major axis of the ellipse is N, and an endpoint of a right-angle side perpendicular to the minor axis of the ellipse is P₁; and denoting coordinates of points M₁, P₁ and N as (xₘ_{ₗ}, yₘ_{ₗ}), (xₚ_{ₗ}, yₚ_{ₗ}) and (xₙ, yₙ) respectively;
step 3-2: setting i=1, and constructing an initially empty set denoted as Γ;
step 3-3: calculating a slope kᵢ of a secant line P̅ᵢ̅P̅ᵢ̅₊̅₁̅ to find an endpoint Pᵢ₊₁ of a next to-be-approximated elliptical arc on an elliptical arc PᵢN after completing one approximation:
where, when an elliptical triangle MᵢPᵢN is in a first or second quadrant, solving an equation shown in a following formula (2) to obtain a slope kᵢ of P̅ᵢ̅P̅ᵢ̅₊̅₁̅, where an intersection between two right-angle sides of the elliptical triangle MᵢPᵢN is Mᵢ, an endpoint of a right-angle side perpendicular to the major axis is N, and an endpoint of a right-angle side perpendicular to the minor axis is Pᵢ;

$$\frac{1}{\sqrt{{k}_{i}^{2} + 1}} [ {k}_{i} ( {x}_{{p}_{i}} + \frac{{a}^{2} {k}_{i}}{\sqrt{{a}^{2} {k}_{i}^{2} + {b}^{2}}} ) - ( {y}_{{p}_{i}} - \frac{{b}^{2}}{\sqrt{{a}^{2} {k}_{i}^{2} + {b}^{2}}} ) ] = eb \qquad ( 2 )$$

where e represents a preset error coefficient, xₚ_{ᵢ} represents an abscissa of the point Pᵢ, and yₚ_{ᵢ} represents an ordinate of the point Pᵢ; and
when the elliptical triangle MᵢPᵢN is in a third or fourth quadrant, solving an equation shown in a following formula (3) to obtain the slope kᵢ of P̅ᵢ̅P̅ᵢ̅₊̅₁̅;

$$\frac{1}{\sqrt{{k}_{i}^{2} + 1}} [ ( {y}_{{p}_{i}} + \frac{{b}^{2}}{\sqrt{{a}^{2} {k}_{i}^{2} + {b}^{2}}} ) - {k}_{i} ( {x}_{{p}_{i}} + \frac{{a}^{2} {k}_{i}}{\sqrt{{a}^{2} {k}_{i}^{2} + {b}^{2}}} ) ] = eb \qquad ( 3 )$$

step 3-4: calculating coordinates of Pᵢ₊₁, and finding an endpoint of a next to-be-approximated elliptical arc on the elliptical arc PᵢN after completing one approximation, where specific steps are as follows:
step 3-4-1: denoting a calculated real root of kᵢ in step 3-3 as kᵢⱼ, where j=1, . . . , τ, τ represents a quantity of real roots of kᵢ, and τ≤4; and setting l=1;
step 3-4-2: setting kᵢ=kᵢₗ, and substituting kᵢ into a following equation set:

$$\{ \begin{matrix}{k}_{i} = \frac{{y}_{{p}_{i + 1}} - {y}_{{p}_{i}}}{{x}_{{p}_{i + 1}} - {x}_{{p}_{i}}} \\ \frac{{x}_{{p}_{i + 1}}^{2}}{{a}^{2}} + \frac{{y}_{{p}_{i + 1}}^{2}}{{b}^{2}} = 1\end{matrix}$$

where the coordinates (xₚ_{ᵢ₊₁}, yₚ_{ᵢ₊₁}) of the point Pᵢ₊₁ are obtained through solving;
step 3-4-3: determining a result obtained in step 3-4-2:
if the point Pᵢ₊₁ is on the elliptical are PᵢN, determining that Pᵢ₊₁ is an endpoint of the next to-be-approximated elliptical arc on the elliptical arc PᵢN after completing the one approximation, and performing step 3-5;
otherwise, performing step 3-4-4; and
step 3-4-4: performing a determination as follows: if l=τ, placing a triangle with vertices N, Pᵢ, and Mᵢ into the set Γ, such that the elliptical triangle M₁P₁N is approximated, and performing step 3-6); or if l<τ, setting l=l+1, and performing step 3-4-2 again;
step 3-5: performing a determination as follows:
if |xₚ_{ᵢ₊₁}−xₘ_{ₗ}|≤eb or |yₚ_{ᵢ₊₁}−yₙ|≤eb, placing the triangle with vertices N, t^{P}^{ᵢ}, a^{M}^{ᵢ} into the set Γ, and performing step 3-6;
otherwise, drawing a perpendicular line from the point Pᵢ₊₁ towards a line segment PᵢMᵢ, and denoting a foot of the perpendicular line as Tᵢ; drawing a perpendicular line from the point Pᵢ₊₁ towards a line segment NMᵢ, and denoting a foot of the perpendicular line as Mᵢ₊₁; based on coordinates of the point Pᵢ₊₁, determining a triangle TᵢPᵢPᵢ₊₁ and a rectangle MᵢTᵢPᵢ₊₁Mᵢ₊₁, and placing the triangle TᵢPᵢPᵢ₊₁ and the rectangle MᵢTᵢPᵢ₊₁Mᵢ₊₁ into the set Γ; and then setting i=i+1, and performing step 3-3 again to continuously approximate an updated elliptical triangle; and
step 3-6: placing all rectangles and triangles in the set Γ into the set W, removing the elliptical triangle M₁P₁N from the set Y, and performing step 4), where all rectangles and triangles in the Γ are approximations of the elliptical triangle M₁P₁N; and
step 4: determining, if the set Y is an empty set, that all rectangles and triangles in the set W form an approximation result of the closed region obtained in step 1; otherwise, returning to step 3-1.

In a specific embodiment of the present disclosure, the method further includes:
repeating steps 1 to 4, and completing the approximation when approximation results of all pairs of nonlinear constraint components of the redundant drive system are obtained.

The present disclosure has the following characteristics and beneficial effects:
1. The present disclosure fully utilizes capability of a secant line in performing high-precision approximation on an elliptical arc, achieving higher approximation efficiency.
2. The present disclosure transforms a nonlinear constraint into a plurality of linear constraints and transforms a nonlinear constraint set into a linear constraint set. This can effectively solve a problem that a control attainable set of a redundant drive system cannot be determined due to a nonlinear constraint relationship between actuators in the redundant drive system.
3. The present disclosure can be used for evaluating control capability of a parallel hybrid system with a redundant driving characteristic and a plurality of nonlinear constraint control component pairs in an advanced satellite, aircraft, ship, automobile, parallel robot, and the like. The present disclosure can provide a basis for control allocation of the system and be used for fault-tolerant control of the system after some actuators fail.

### BRIEF DESCRIPTION OF THE DRAWINGS

FIG. 1 is an overall flowchart of a secant line approximation method for a nonlinear constraint of a redundant drive system according to an embodiment of the present disclosure;

FIG. 2 is a schematic diagram of a closed region formed by intersecting a rectangle and an ellipse according to a specific embodiment of the present disclosure;

FIG. 3 is a schematic diagram of another closed region formed by intersecting a rectangle and an ellipse according to a specific embodiment of the present disclosure;

FIG. 4 is a schematic diagram of a secant line approximation of an elliptical triangle according to a specific embodiment of the present disclosure; and

FIG. 5 is a schematic diagram of a secant line approximation for a nonlinear constraint of a driving wheel of a redundant drive vehicle according to a specific embodiment of the present disclosure.

### DETAILED DESCRIPTION OF THE EMBODIMENTS

The present disclosure provides a secant line approximation method for a nonlinear constraint of a redundant drive system. The following provides further detailed description based on the accompanying drawings and specific embodiments.

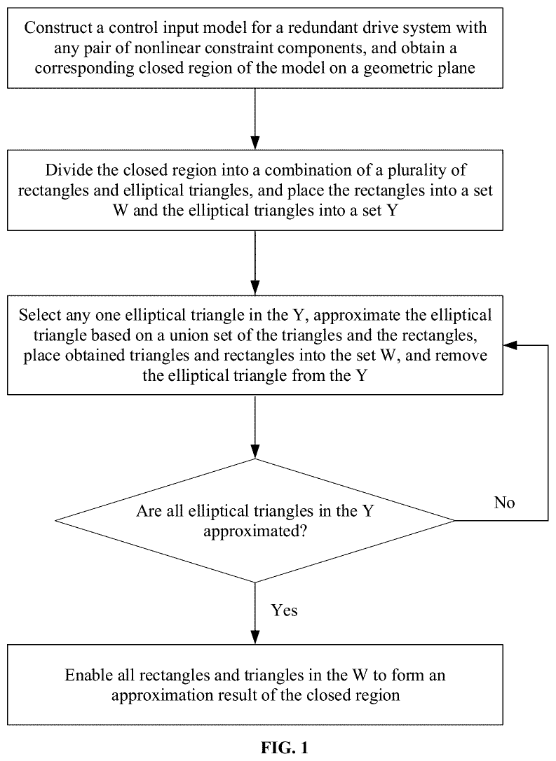

An embodiment of the present disclosure provides a secant line approximation method for a nonlinear constraint of a redundant drive system. An overall process is shown in FIG. 1. The method includes the following step 1 to step 5.

Step 1: a control input model for a redundant drive system with any pair of nonlinear constraint components is constructed, and a corresponding closed region of the model on a geometric plane is obtained.

In a specific embodiment of the present disclosure, the control input model for the redundant drive system with any pair of nonlinear constraint components is expressed as follows:

$$\{ \begin{matrix}\frac{{u}_{1}^{2}}{{a}^{2}} + \frac{{u}_{2}^{2}}{{b}^{2}} \leq 1 \\ {u}_{1 min} \leq {u}_{1} \leq {u}_{1 max} \\ {u}_{2 min} \leq {u}_{2} \leq {u}_{2 max}\end{matrix} \qquad ( 1 )$$

In the above formula, u₁ and u₂ respectively represent two control actions in the pair of nonlinear constraint components, −a≤u₁≤a represents a corresponding range of the control action u₁, −b≤u₂≤b represents a corresponding range of the control action u₂, uᵢₘᵢₙ represents a minimum value of a current control action of an i^{th} actuator, uᵢₘₐₓ represents a maximum value of the current control action of the i^{th} actuator, i=1,2, −a≤u₁ₘᵢₙ<u₁ₘₐₓ≤a, and −b≤u₂ₘᵢₙ<u₂ₘₐₓ≤b. The model described in the formula (1) is geometrically represented as a closed region formed by intersecting a rectangle and an ellipse.

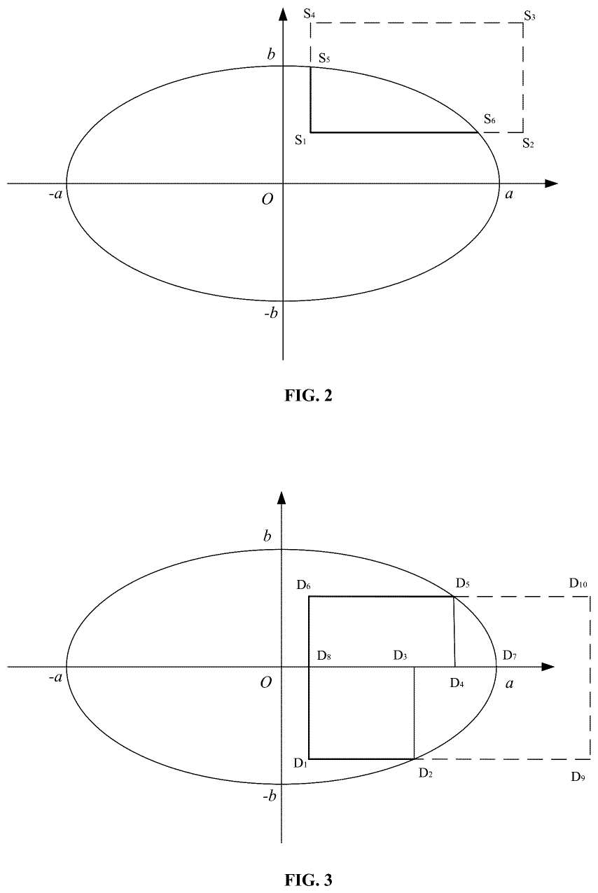

FIG. 2 is a schematic diagram of a closed region formed by intersecting a rectangle and an ellipse according to a specific embodiment of the present disclosure. For the ellipse, a center is at an origin, a length of a semi-major axis is a, and a length of a semi-minor axis is b. For the rectangle, a lower left vertex is S₁, a length is u₁ₘₐₓ−u₁ₘᵢₙ, and a width is u₂ₘₐₓ−u₂ₘᵢₙ. Due to different values of uᵢₘᵢₙ and uᵢₘₐₓ at different time points, the rectangle is located at different positions at the different time points.

Therefore, a secant line approximation of a nonlinear constraint is how to use a combination of the rectangles and the triangles to approximate a geometric figure formed by the nonlinear constraint, to achieve a linear approximation with higher accuracy and fewer figures for the nonlinear constraint.

Step 2: the closed region in step 1 is divided into a combination of rectangles and elliptical triangles.

In this embodiment, the elliptical triangle is defined as a figure enclosed by two right-angle sides of a right triangle and an elliptical arc connecting two vertices of a hypotenuse of the right triangle. FIG. 2 is a schematic diagram of the elliptical triangle. In FIG. 2, a figure formed by connecting a line segment S₁S₆, an elliptical arc S₆S₅, and a line segment S₅S₁ in an end-to-end manner is an elliptical triangle.

Perpendicular lines are separately drawn from intersections between the rectangle and the ellipse towards a major axis and a minor axis of the ellipse, the closed region formed by intersecting the rectangle and the ellipse is divided into a union set of the rectangles and the elliptical triangles, the rectangles in the union set are placed into an initially empty set W, and the elliptical triangles are placed into an initially empty set Y. FIG. 3 is a schematic diagram of another closed region formed by intersecting a rectangle and an ellipse according to a specific embodiment of the present disclosure. As shown in FIG. 3, a region that is formed by intersecting a rectangle D₁D₉D₁₀D₆ and an ellipse and obtained according to the formula (1) is a closed region enclosed by a line segment D₁D₂, an elliptical arc D₂D₇, an elliptical arc D₇D₅, a line segment D₅D₆, a line segment D₆D₈, and a line segment D₈D₁. The region formed by intersecting the rectangle and the ellipse can be divided into a rectangle D₁D₂D₃D₈, a rectangle D₄D₅D₆D₈, an elliptical triangle D₃D₂D₇, and an elliptical triangle D₄D₇D₅ by separately drawing perpendicular lines from an intersection D₂ between the rectangle D₁D₉D₁₀D₆ and the ellipse towards the major axis and the minor axis of the ellipse, and by separately drawing perpendicular lines form an intersection D₅ between the rectangle D₁D₉D₁₀D₆ and the ellipse towards the major axis and the minor axis of the ellipse. It should be noted that in the example shown in FIG. 3, the region formed by intersecting the rectangle and the ellipse is divided into two rectangles and two elliptical triangles. However, in other cases, quantities of rectangles and elliptical triangles divided from different closed regions are different.

Step 3: based on the combination of the rectangles and the triangles, the elliptical triangles obtained in step 2 are approximated. Specific steps are as follows:

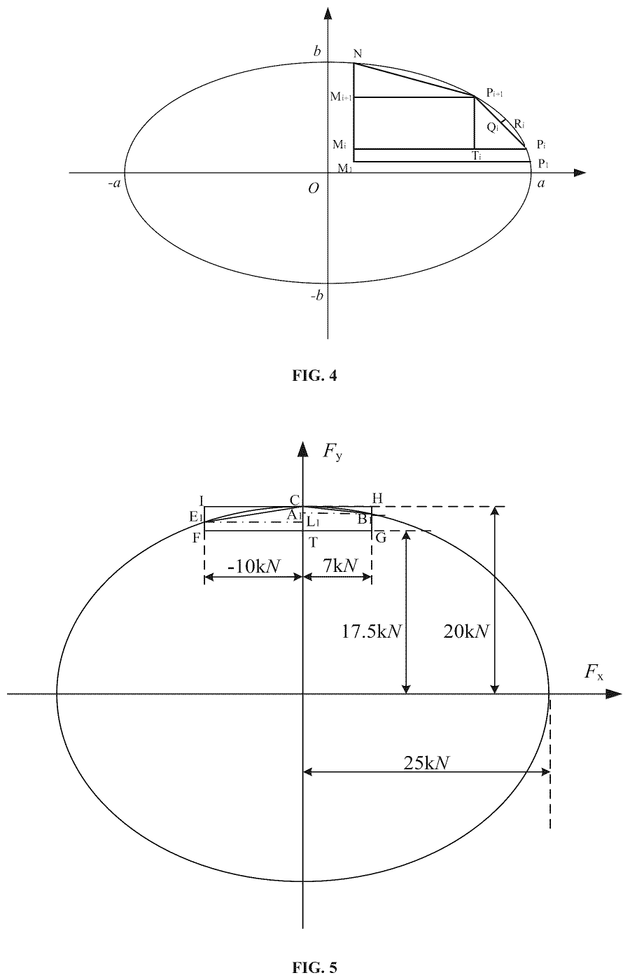

Step 3-1: any elliptical triangle in the set Y is selected, and the elliptical triangle is denoted as M₁P₁N. In a specific embodiment of the present disclosure, a schematic diagram of a secant line approximation of the elliptical triangle is shown in FIG. 4. In FIG. 4, an intersection between two right-angle sides of the elliptical triangle is M₁, the other endpoint of the right-angle side perpendicular to the major axis of the ellipse is N, and the other endpoint of the right-angle side perpendicular to the minor axis of the ellipse is P₁. Coordinates of the points M₁, P₁ and N are respectively denoted as (xₘ_{ₗ}, yₘ_{ₗ}), (xₚ_{ₗ}, yₚ_{ₗ}) and (xₙ, yₙ). For the ellipse, the length of the semi-major axis is a, and the length of the semi-minor axis is b. All the above data is known.

Step 3-2: i=1 is set, and an initially empty set is constructed and denoted as Γ.

Step 3-3: a slope kᵢ of a secant line P̅ᵢ̅P̅ᵢ̅₊̅₁̅ is calculated to find an endpoint Pᵢ₊₁ of a next to-be-approximated elliptical arc on an elliptical arc PᵢN after completing one approximation.

When an elliptical triangle MᵢPᵢN is in a first or second quadrant, an equation shown in a following formula (2) is solved to obtain the slope kᵢ of P̅ᵢ̅P̅ᵢ̅₊̅₁̅. An intersection between two right-angle sides of the elliptical triangle MᵢPᵢN is Mᵢ, an endpoint of the right-angle side perpendicular to the major axis is N, and an endpoint of the right-angle side perpendicular to the minor axis is Pᵢ. Due to existence of the slope of P̅ᵢ̅P̅ᵢ̅₊̅₁̅, the equation shown in the following formula (2) must have a solution.

$$\frac{1}{\sqrt{{{k}_{i}}^{2} + 1}} [ {k}_{i} ( {x}_{{p}_{i}} + \frac{{a}^{2} {k}_{i}}{\sqrt{{a}^{2} {{k}_{i}}^{2} + {b}^{2}}} ) - ( {y}_{{p}_{i}} - \frac{{b}^{2}}{\sqrt{{a}^{2} {{k}_{i}}^{2} + {b}^{2}}} ) ] = eb \qquad ( 2 )$$

In the above formula, e presents a preset error coefficient. In this embodiment, 0<e≤0.05. xₚ_{ᵢ} represents an abscissa of the point Pᵢ, and yₚ_{ᵢ} represents an ordinate of the point Pᵢ.

When the elliptical triangle MᵢPᵢN is in a third or fourth quadrant, an equation shown in a following formula (3) is solved to obtain the slope kᵢ of P̅ᵢ̅P̅ᵢ̅₊̅₁̅. Due to the existence of the slope of P̅ᵢ̅P̅ᵢ̅₊̅₁̅, the equation shown in the following formula (3) must have a solution.

$$\frac{1}{\sqrt{{{k}_{i}}^{2} + 1}} [ ( {y}_{{p}_{i}} + \frac{{b}^{2}}{\sqrt{{a}^{2} {{k}_{i}}^{2} + {b}^{2}}} ) - {k}_{i} ( {x}_{{p}_{i}} - \frac{{a}^{2} {k}_{i}}{\sqrt{{a}^{2} {{k}_{i}}^{2} + {b}^{2}}} ) ] = eb \qquad ( 3 )$$

It should be noted that in this embodiment, the equation shown in the formula (2) and the equation shown in the formula (3) are derived based on a following process:

A point is found on the elliptical arc PᵢN and denoted as Pᵢ₊₁. Coordinates of Pᵢ₊₁ are denoted as (xₚ_{ᵢ₊₁}, yₚ_{ᵢ₊₁}), where xₚ_{ᵢ₊₁} represents an abscissa of Pᵢ₊₁, and yₚ_{ᵢ₊₁} represents an ordinate of Pᵢ₊₁. The secant line P̅ᵢ̅P̅ᵢ̅₊̅₁̅ is made. A point Rᵢ is found on an elliptical arc P̅ᵢ̅P̅ᵢ̅₊̅₁̅. Coordinates of Rⁱ are denoted as (xᵣ_{ᵢ}, yᵣ_{ᵢ}), where xᵣ_{ᵢ} represents an abscissa of the Rᵢ, and yᵣ_{ᵢ} represents an ordinate of the Rᵢ. A perpendicular line is made from the point towards the secant line P̅ᵢ̅P̅ᵢ̅₊̅₁̅, with a foot of the perpendicular line denoted as Qᵢ. Coordinates of Qᵢ are denoted as (x_{q}_{ᵢ}, y_{q}_{ᵢ}), where x_{q}_{ᵢ} represents an abscissa of Qᵢ, and y_{q}_{ᵢ} represents an ordinate of Qᵢ. Therefore, an slope of the secant line P̅ᵢ̅P̅ᵢ̅₊̅₁̅ is

$${k}_{i} = \frac{{y}_{{p}_{i + 1}} - {y}_{{p}_{i}}}{{x}_{{p}_{i + 1}} - {x}_{{p}_{i}}} .$$

A length of a perpendicular line segment R̅ᵢ̅Q̅ᵢ̅ is denoted as |R̅ᵢ̅Q̅ᵢ̅| where |R̅ᵢ̅Q̅ᵢ̅|=(x_{q}_{ᵢ}−xᵣ_{ᵢ})²+(y_{q}_{ᵢ}−yᵣ_{ᵢ})² and f(xᵣ_{ᵢ})=|R̅ᵢ̅Q̅ᵢ̅| are set. It can be obtained that:

$$f ( {x}_{{r}_{i}} ) = \{ \begin{matrix}\frac{1}{\sqrt{{{k}_{i}}^{2} + 1}} [ {k}_{i} ( {x}_{{p}_{i}} - {x}_{{r}_{i}} ) - ( {y}_{{p}_{i}} - \frac{{b}^{2}}{\sqrt{{a}^{2} {{k}_{i}}^{2} + {b}^{2}}} ) ] , \\ when the elliptical triangle {M}_{1} {P}_{1} N is in a first or second quadrant \\ \frac{1}{\sqrt{{{k}_{i}}^{2} + 1}} [ ( {y}_{{p}_{i}} + \frac{{b}^{2}}{\sqrt{{a}^{2} {{k}_{i}}^{2} + {b}^{2}}} ) - {k}_{i} ( {x}_{{p}_{i}} - {x}_{{r}_{i}} ) ] , \\ when the elliptical triangle {M}_{1} {P}_{1} N is in a third or fourth quadrant\end{matrix}$$

A derivative about xᵣ_{ᵢ} is obtained for the f(xᵣ_{ᵢ}), and

$$\frac{df ( {x}_{{r}_{i}} )}{{dx}_{{r}_{i}}} = 0$$

is set. It can be obtained that:

$${x}_{{r}_{i}} = \{ \begin{matrix}\frac{- {a}^{2} {k}_{i}}{\sqrt{{a}^{2} {{k}_{i}}^{2} + {b}^{2}}} , \\ when the elliptical triangle is in a first or second quadrant \\ \frac{{a}^{2} {k}_{i}}{\sqrt{{a}^{2} {{k}_{i}}^{2} + {b}^{2}}} , \\ when the elliptical triangle is in a third or fourth quadrant\end{matrix} \qquad ( 4 )$$

$${y}_{{r}_{i}} = \{ \begin{matrix}\frac{{b}^{2}}{\sqrt{{a}^{2} {{k}_{i}}^{2} + {b}^{2}}} , \\ when the elliptical triangle is in a first or second quadrant \\ \frac{- {b}^{2}}{\sqrt{{a}^{2} {{k}_{i}}^{2} + {b}^{2}}} , \\ when the elliptical triangle is in a third or fourth quadrant\end{matrix} \qquad ( 5 )$$

The xᵣ_{ᵢ} is substituted into f(xᵣ_{ᵢ})=|R̅ᵢ̅Q̅ᵢ̅|, and |R̅ᵢ̅Q̅ᵢ̅|=eb is set. When the elliptical triangle is in the first or second quadrant, a following equation can be obtained:

$$\frac{1}{\sqrt{{{k}_{i}}^{2} + 1}} [ {k}_{i} ( {x}_{{p}_{i}} + \frac{{a}^{2} {k}_{i}}{\sqrt{{a}^{2} {{k}_{i}}^{2} + {b}^{2}}} ) - ( {y}_{{p}_{i}} - \frac{{b}^{2}}{\sqrt{{a}^{2} {{k}_{i}}^{2} + {b}^{2}}} ) ] = eb .$$

When the elliptical triangle is in the third or fourth quadrant, a following equation can be obtained:

$$\frac{1}{\sqrt{{{k}_{i}}^{2} + 1}} [ ( {y}_{{p}_{i}} + \frac{{b}^{2}}{\sqrt{{a}^{2} {{k}_{i}}^{2} + {b}^{2}}} ) - {k}_{i} ( {x}_{{p}_{i}} - \frac{{a}^{2} {k}_{i}}{\sqrt{{a}^{2} {{k}_{i}}^{2} + {b}^{2}}} ) ] = eb$$

Step 3-4: the coordinates of Pᵢ₊₁ is calculated, and an endpoint of a next to-be-approximated elliptical arc on the elliptical arc PᵢN is found after completing the one approximation. Specific steps are as follows:

Step 3-4-1: due to non-uniqueness of kᵢ calculated in step 3-3, a real root of the kᵢ is denoted as kᵢⱼ, where j=1, . . . , τ, τ represents a quantity of real roots of the kᵢ, τ≤4, and l=1.

Step 3-4-2: kᵢ=kᵢₗ is set, and kᵢ is substituted into a following equation set:

$$\{ \begin{matrix}{k}_{i} = \frac{{y}_{{p}_{i + 1}} - {y}_{{p}_{i}}}{{x}_{{p}_{i + 1}} - {x}_{{p}_{i}}} \\ \frac{{x}_{{p}_{i + 1}}^{2}}{{a}^{2}} + \frac{{y}_{{p}_{i + 1}}^{2}}{{b}^{2}} = 1\end{matrix}$$

where the coordinates (xₚ_{ᵢ₊₁}, yₚ_{ᵢ₊₁}) of the point Pᵢ₊₁ are obtained through solving.

Step 3-4-3: a result of step 3-4-2 is determined: If the point Pᵢ₊₁ is on the elliptical arc PᵢN, it is determined that the point Pᵢ₊₁ is the endpoint of the next to-be-approximated elliptical arc on the elliptical arc PᵢN after completing the one approximation, and step 3-5 is performed.

Otherwise, step 3-4-4 is performed.

Step 3-4-4: if l=τ, a triangle with vertices N, Pᵢ and Mᵢ is placed into the set Γ, such that the elliptical triangle M₁P₁N is approximated, and step 3-6 is performed; or if l<τ, l=l+1 is set, and step 3-4-2 is performed again.

Step 3-5: the following determination is performed as follows:

If |xₚ_{ᵢ₊₁}−xₘ_{ₗ}|≤eb or |yₚ_{ᵢ₊₁}−yₙ|≤eb, the triangle with vertices N, Pᵢ and Mᵢ placed into the set Γ, and step 3-6 is performed.

Otherwise, a perpendicular line is drawn from the point Pᵢ₊₁ towards a line segment PᵢMᵢ, and a foot of the perpendicular line is denoted as Tᵢ; a perpendicular line is drawn from the point Pᵢ₊₁ towards a line segment NMᵢ, and a foot of the perpendicular is denoted as Mᵢ₊₁; based on the coordinates of the point Pᵢ₊₁, a triangle TᵢPᵢPᵢ₊₁ and a rectangle MᵢTᵢPᵢ₊₁Mᵢ₊₁ are determined, and the triangle TᵢPᵢPᵢ₊₁ and the rectangle MᵢTᵢPᵢ₊₁Mᵢ₊₁ are placed into the set Γ; and then i=i+1 is set, and step 3-3 is performed again to continuously approximate an updated elliptical triangle.

Step 3-6: all rectangles and triangles in the set Γ are placed into the set W, and the elliptical triangle M₁P₁N is removed from the set Y, where all the rectangles and triangles in the Γ are approximations of the elliptical triangle M₁P₁N. Step 4 is performed.

Step 4: if the set Y is an empty set, it is determined that all rectangles and triangles in the set W form an approximation result of the closed region formed by intersecting a rectangle and an ellipse that are corresponding to one nonlinear constraint pair obtained in step 1; otherwise, step 3-1 is performed.

Further, the method in the present disclosure further includes the following step:

Step 5: steps 1 to 4 are repeated, and the approximation is completed when approximation results of all pairs of nonlinear constraint components of the redundant drive system are obtained.

In this embodiment, after the approximation result of the nonlinear constraint is obtained, a control attainable set algorithm for a linear constraint is called to calculate a control attainable subset corresponding to each rectangle and triangle constraint in the approximation result. After the calculation is completed, a union set of all control attainable subsets is taken to obtain a control attainable set corresponding to the nonlinear constraint, so as to control the redundant drive system.

The method in the present disclosure is further described below with reference to a specific embodiment.

### EMBODIMENT

In a specific embodiment of the present disclosure, a secant line approximation is performed for a nonlinear constraint of a driving wheel of a redundant drive vehicle.

When one driving wheel is in a combined driving/braking and steering condition, longitudinal force Fₓ and lateral force F_{y} of a tire are generated. The longitudinal force Fₓ and the lateral force F_{y} are two actuators that follow an elliptical nonlinear relationship. FIG. 5 is a schematic diagram of the secant line approximation for the nonlinear constraint of the driving wheel of the redundant drive vehicle according to a specific embodiment of the present disclosure. An ellipse in FIG. 5 shows minimum and maximum values of the longitudinal force Fₓ and the lateral force F_{y} that the tire can provide under a given load, road condition, tire pressure, tire slip rate, and tire sideslip angle (−25 kN≤Fₓ≤25 kN, and −20 kN≤F_{y}≤20 kN). In this embodiment, a=25, b=20. Therefore, there is an elliptical nonlinear relationship between the Fₓ and the

$${F}_{y} ( \frac{{F}_{x}^{2}}{{25}^{2}} + \frac{{F}_{y}^{2}}{{20}^{2}} \leq 1 )$$

(BOSCH Automotive Handbook, translated by Gu Bailiang et al., Beijing Institute of Technology Press, 2nd edition, February 2004). In FIG. 5, the intersection of a rectangle FGHI and the ellipse forms a figure composed of an elliptical arc E₁CB₁, a line segment E₁F, a line segment FG, and a line segment GB₁, which represents ranges of the longitudinal force Fₓ and the lateral force F_{y} that the tire can provide at a specific time point (in this case, −10 kN≤Fₓ≤7 kN, 17.5 kN≤F_{y}≤20 kN, and

$$\frac{{F}_{x}^{2}}{{25}^{2}} + \frac{{F}_{y}^{2}}{{20}^{2}} \leq 1 ) .$$

It is required that a linear approximation is performed on a closed region formed by intersecting the rectangle FGHI and the ellipse.

In this embodiment, the secant line approximation method for a nonlinear constraint of a redundant drive system includes the following steps. Step 1: a control input model for a redundant drive system with any pair of nonlinear constraint components is constructed, and a corresponding closed region of the model on a geometric plane is obtained.

This embodiment is intended to use a combination of the rectangles and the triangles to approximate the region formed by intersecting the rectangle and the ellipse, in other words, the region enclosed by the line segment E₁F, the line segment FG, the line segment GB₁, an arc B₁C, and an arc CE₁ in FIG. 5. In FIG. 5, four vertices of the rectangle are points F, G, H and I with coordinates (−10, 17.5), (7, 17.5), (7, 20) and (−10, 20) respectively. Intersections between the rectangle and the ellipse are B₁, C and E₁, with coordinates (7, 19.2), (0, 20) and (−10, 18.33) respectively. T is an intersection between a side FG of the rectangle and a minor axis of the ellipse, and its coordinates are (0, 17.5).

Step 2: the closed region in step 1 is divided into a union set of a plurality of rectangles and a plurality of elliptical triangles.

In this embodiment, the region formed by intersecting the rectangle and the ellipse is the region enclosed by the line segment E₁F, the line segment FG, the line segment GB₁, the arc B₁C and the arc CE₁. A perpendicular line is drawn from the point E₁ towards a major axis of the ellipse, with a foot of the perpendicular line L₁. A perpendicular line is drawn from the point B₁ to the minor axis of the ellipse, with a foot of the perpendicular line A₁. In this case, the region formed by intersecting the rectangle and the ellipse is a union set of a rectangle FTL₁E₁, a rectangle TGB₁A₁, an elliptical triangle A₁B₁C and an elliptical triangle L₁E₁C. The rectangle FTL₁E₁ and the rectangle TGB₁A₁ are placed into a set W₁, and the elliptical triangle A₁B₁C and the elliptical triangle L₁E₁C are placed into a set Y₁.

Step 3: based on a combination of the rectangles and the triangles, the elliptical triangle obtained in step 2 is approximated. Specific steps are as follows:

Step 3-1: the elliptical triangle A₁B₁C is selected in the set Y₁, with coordinates of the points A₁, B₁ and C being (0, 19.2), (7, 19.2) and (0, 20) respectively. A length of a semi-major axis of the ellipse is a=25, and a length of a semi-minor axis is b=20. The points A₁, B₁ and C correspond to points M₁, P₁ and N in algorithm steps. Therefore, xₘ_{ₗ}=0, yₘ_{ₗ}=19.2, xₚ_{ₗ}=7, yₚ_{ₗ}=19.2, and xₙ=0, yₙ=20.

Step 3-2: i=1 is set, and an initially empty set is constructed and denoted as Γ₁.

Step 3-3: because the elliptical triangle A₁B₁C is in a first quadrant, a following equation is solved:

$$\frac{1}{\sqrt{{{k}_{1}}^{2} + 1}} [ {k}_{1} ( 7 + \frac{625 {k}_{1}}{\sqrt{625 {{k}_{1}}^{2} + 400}} ) - ( 19.2 - \frac{400}{\sqrt{625 {{k}_{1}}^{2} + 400}} ) ] = 0.2$$

Two real roots, −0.1148 and −0.3603, are obtained. An error coefficient is e. In this embodiment, e=0.01.

Step 3-4: by solving coordinates of a point P₂, an endpoint of a next to-be-approximated elliptical arc on an elliptical arc P₁N is found after completing one approximation. Specific steps are as follows:

Step 3-4-1: the two real roots calculated in step 3-3 are denoted as k₁₁ and k₁₂, where k₁₁=−0.1148, and k₁₂=−−0.3603.

Step 3-4-2: k₁=k₁₁ is set, and k₁ is substituted into a following equation set:

$$\{ \begin{matrix}{k}_{1} = \frac{{y}_{{p}_{2}} - 19.2}{{x}_{{p}_{2}} - 7} \\ \frac{{x}_{{p}_{2}}^{2}}{625} + \frac{{y}_{{p}_{2}}^{2}}{400} = 1\end{matrix}$$

The coordinates (xₚ_{₂}, yₚ_{₂}) of P₂ are obtained through solving, where xₚ_{₂}=0.03078, yₚ_{₂}=19.99998. Then step 3-4-3 is performed.

Step 3-4-3: because the point P2 is on the elliptical arc P₁N, step 3-5 is performed.

Step 3-5: if |yₙ−yₚ_{₂}<eb=0.2, step 3-6 is performed.

Step 3-6: the triangle with vertices A₁, B₁ and C is placed into Γ₁, where all rectangles and triangles in Γ₁ are approximations of the elliptical triangle A₁B₁C; and all the rectangles and triangles in the Γ₁ are placed into the set W₁, and the elliptical triangle A₁B₁C is removed from the set Y₁. Then, step 4 is performed.

Step 4: if the set Y₁ is an empty set, step 3-1 is performed again.

Step 3-1: an elliptical triangle L₁E₁C is selected in the set Y₁, with coordinates of points L₁, E₁ and C being (0, 18.33), (−10, 18.33) and (0, 20) respectively. A length of a semi-major axis of the ellipse is a=25, and a length of a semi-minor axis is b=20. The points L₁, E₁ and C correspond to points M₁, P₁ and N in algorithm steps. Therefore, xₘ_{ₗ}=0, yₘ_{ₗ}=18.33, xₚ_{ₗ}=−10, yₚ_{ₗ}=18.33, and xₙ=0, yₙ=20.

Step 3-2: i=1 is set, and an initially empty set is constructed and denoted as Γ₂.

Step 3-3: because the elliptical triangle L₁E₁C is in a second quadrant, a following equation is solved:

$$\frac{1}{\sqrt{{{k}_{1}}^{2} + 1}} [ {k}_{1} ( - 10 + \frac{625 {k}_{1}}{\sqrt{625 {{k}_{1}}^{2} + 400}} ) - ( 18.33 - \frac{400}{\sqrt{625 {{k}_{1}}^{2} + 400}} ) ] = 0.2$$

Two real roots, 0.2223 and 0.4898, are obtained.

Step 3-4: by solving coordinates of a point P₂, an endpoint of a next to-be-approximated elliptical arc on the elliptical arc P₁N is found after completing one approximation. Specific steps are as follows:

Step 3-4-1: the two real roots calculated in step 3-3 are denoted as k₁₁ and k₁₂, where k₁₁=0.2223, and k₁₂=0.4898.

Step 3-4-2: k₁=k₁₁ is set, and k₁ is substituted into a following equation set:

$$\{ \begin{matrix}{k}_{1} = \frac{{y}_{{p}_{2}} - 18.33}{{x}_{{p}_{{p}_{2}}} + 10} \\ \frac{{x}_{{p}_{2}}^{2}}{625} + \frac{{y}_{{p}_{2}}^{2}}{400} = 1\end{matrix}$$

The coordinates (xₚ_{₂}, yₚ_{₂}) of P₂ are obtained through solving, where xₚ_{₂}=−3.2505, yₚ_{₂}=19.8302. Then step 3-4-3 is performed.

Step 3-4-3: because the point P₂ is on the elliptical arc P₁N, step 3-5 is performed.

Step 3-5: if |yₙ−yₚ_{₂}|<eb=0.2, step 3-6 is performed.

Step 3-6: the triangle with vertices L₁, E₁ and C is placed into Γ₂, where all rectangles and triangles in Γ₂ are approximations of the elliptical triangle L₁E₁C; and all the rectangles and triangles in the Γ₂ are placed into the set W₁, and the elliptical triangle L₁E₁C is removed from the set Y₁. Then, step 4 is performed.

Step 4: if the set Y₁ is an empty set, the algorithm is ended, where a figure formed by all the rectangles and triangles in the W₁ is a linear approximation of the closed region formed by intersecting the rectangle and the ellipse.

In conclusion, the foregoing are merely descriptions of preferred embodiments of the present disclosure, and are not intended to limit the protection scope of the present disclosure. Any modification, equivalent substitution, improvement, etc. within the spirit and principles of the present disclosure shall fall within the scope of protection of the present disclosure.

1. A secant line approximation method for a nonlinear constraint of a redundant drive system, comprising:
step 1: constructing a control input model for a redundant drive system with any pair of nonlinear constraint components, and obtaining a corresponding closed region of the model that is formed by intersecting a rectangle and an ellipse on a geometric plane, wherein
the control input model for the redundant drive system with the pair of nonlinear constraint components is expressed as follows:
$$\{ \begin{matrix}\frac{{u}_{1}^{2}}{{a}^{2}} + \frac{{u}_{2}^{2}}{{b}^{2}} \leq 1 \\ {u}_{1 min} \leq {u}_{1} \leq {u}_{1 max} \\ {u}_{2 min} \leq {u}_{2} \leq {u}_{2 max}\end{matrix} \qquad ( 1 )$$
wherein u₁ and u₂ respectively represent two control actions in the pair of nonlinear constraint components, −a≤u₁≤a represents a corresponding range of the control action u₁, −b≤u₂≤b represents a corresponding range of the control action u₂, uᵢₘᵢₙ represents a minimum value of a current control action of an i^{th} actuator, uᵢₘₐₓ represents a maximum value of the current control action of the i^{th} actuator, i=1, 2, −a≤u₁ₘᵢₙ<u₁ₘₐₓ≤a, and −b≤u₂ₘᵢₙ<u₂ₘₐₓ≤b; and
in the closed region, lengths of a semi-major axis and a semi-minor axis of the ellipse are a and b respectively; and a length and a width of the rectangle are u₁ₘₐₓ-u₁ₘᵢₙ and u₂ₘₐₓ-u₂ₘᵢₙ respectively;
step 2: based on the closed region obtained in step 1, separately drawing a perpendicular line from an intersection between the rectangle and the ellipse towards a major axis and a minor axis of the ellipse, dividing the closed region into a union set of rectangles and elliptical triangles, and placing the rectangles in the union set into an initially empty set W and the elliptical triangles into an initially empty set Y;
wherein each elliptical triangle is a figure enclosed by two right-angle sides of a right triangle and an elliptical arc connecting two vertices of a hypotenuse of the right triangle;
step 3: approximating, based on a combination of rectangles and triangles, an elliptical triangle obtained in step 2, wherein specific steps are as follows:
step 3-1: selecting any elliptical triangle in the set Y, and denoting the elliptical triangle as M₁P₁N, wherein an intersection between two right-angle sides of the elliptical triangle is M₁, an endpoint of a right-angle side perpendicular to the major axis of the ellipse is N, and an other endpoint of a right-angle side perpendicular to the minor axis of the ellipse is P₁; and denoting coordinates of points M₁P₁, and N as (xₘ_{ₗ}, yₘ_{ₗ}), (xₚ_{ₗ}, yₚ_{ₗ}) and (xₙ, yₙ) respectively;
step 3-2: setting i=1, and constructing an initially empty set denoted as F;
step 3-3: calculating a slope kᵢ of a secant line P̅ᵢ̅P̅ᵢ̅₊̅₁̅ to find an endpoint Pᵢ₊₁ of a next to-be-approximated elliptical arc on an elliptical arc PᵢN after completing one approximation,
wherein, when an elliptical triangle MᵢPᵢN is in a first or second quadrant, solving an equation shown in a following formula (2) to obtain a slope kᵢ of P̅ᵢ̅P̅ᵢ̅₊̅₁̅, wherein an intersection between two right-angle sides of the elliptical triangle MᵢPᵢN is Mᵢ, an endpoint of a right-angle side perpendicular to the major axis is N, and an other endpoint of a right-angle side perpendicular to the minor axis is Pᵢ;
$$\frac{1}{\sqrt{{k}_{i}^{2} + 1}} [ {k}_{i} ( {x}_{{p}_{i}} + \frac{{a}^{2} {k}_{i}}{\sqrt{{a}^{2} {k}_{i}^{2} + {b}^{2}}} ) - ( {y}_{{p}_{i}} - \frac{{b}^{2}}{\sqrt{{a}^{2} {k}_{i}^{2} + {b}^{2}}} ) ] = eb \qquad ( 2 )$$
wherein e represents a preset error coefficient, xₚ_{ᵢ} represents an abscissa of the point Pᵢ, and yₚ_{ᵢ} represents an ordinate of the point Pᵢ; and
when the elliptical triangle MᵢPᵢN is in a third or fourth quadrant, solving an equation shown in a following formula (3) to obtain the slope kᵢ of P̅ᵢ̅P̅ᵢ̅₊̅₁̅;
$$\frac{1}{\sqrt{{k}_{i}^{2} + 1}} [ ( {y}_{{p}_{i}} + \frac{{b}^{2}}{\sqrt{{a}^{2} {k}_{i}^{2} + {b}^{2}}} ) - {k}_{i} ( {x}_{{p}_{i}} + \frac{{a}^{2} {k}_{i}}{\sqrt{{a}^{2} {k}_{i}^{2} + {b}^{2}}} ) ] = eb \qquad ( 3 )$$
step 3-4: calculating coordinates of Pᵢ₊₁, and finding an endpoint of a next to-be-approximated elliptical arc on the elliptical arc PᵢN after completing one approximation, wherein specific steps are as follows:
step 3-4-1: denoting a calculated real root of kᵢ in step 3-3 as kᵢⱼ, wherein j=1, . . . , τ, τ represents a quantity of real roots of kᵢ, and τ≤4; and setting l=1;
step 3-4-2: setting kᵢ=kᵢₗ, and substituting kᵢ into a following equation set:
$$\{ \begin{matrix}{k}_{i} = \frac{{y}_{{p}_{i + 1}} - {y}_{{p}_{i}}}{{x}_{{p}_{i + 1}} - {x}_{{p}_{i}}} \\ \frac{{x}_{{p}_{i + 1}}^{2}}{{a}^{2}} + \frac{{y}_{{p}_{i + 1}}^{2}}{{b}^{2}} = 1\end{matrix}$$
wherein coordinates (xₚ_{ᵢ₊₁}, yₚ_{ᵢ₊₁}) of the point Pᵢ₊₁ are obtained through solving;
step 3-4-3: determining a result obtained in step 3-4-2:
if the point Pᵢ₊₁ is on the elliptical arc PᵢN, determining that Pᵢ₊₁ is an endpoint of the next to-be-approximated elliptical arc on the elliptical arc PᵢN after completing the one approximation, and performing step 3-5;
otherwise, performing step 3-4-4; and
step 3-4-4: performing a determination as follows: if l=τ, placing a triangle with vertices N, Pᵢ and Mᵢ into the set Γ, such that the elliptical triangle MₗPₗN is approximated, and performing step 3-6; or if l<τ, setting l=l+1 and performing step 3-4-2 again;
step 3-5: performing a determination as follows:
if |xₚ_{ᵢ₊₁}−xₘ_{ₗ}|≤eb or |yₚ_{ᵢ₊₁}−yₙ|≤eb, placing a triangle with vertices N, Pᵢ and Mᵢ into the set Γ, and performing step 3-6;
otherwise, drawing a perpendicular line from the point Pᵢ₊₁ towards a line segment PᵢMᵢ, and denoting a foot of the perpendicular line as Tᵢ; drawing a perpendicular line from the point Pᵢ₊₁ towards a line segment NMᵢ, and denoting a foot of the perpendicular line as Mᵢ₊₁; based on coordinates of the point Pᵢ₊₁, determining a triangle TᵢPᵢPᵢ₊₁ and a rectangle MᵢTᵢPᵢ₊₁Mᵢ₊₁, and placing the triangle TᵢPᵢPᵢ₊₁ and the rectangle MᵢTᵢPᵢ₊₁Mᵢ₊₁ into the set Γ; and then setting i=i+1, and performing step 3-3 again to continuously approximate an updated elliptical triangle; and
step 3-6: placing all rectangles and triangles in the set Γ into the set W, removing the elliptical triangle MₗPₗN from the set Y, and performing step 4, wherein all rectangles and triangles in the F are approximations of the elliptical triangle MₗPₗN; and
step 4: determining, if the set Y is an empty set, that all rectangles and triangles in the set W form an approximation result of the closed region obtained in step 1; otherwise, returning to step 3-1.

2. The method according to claim 1, further comprising:
repeating steps 1 to 4, and completing the approximation when approximation results of all pairs of nonlinear constraint components of the redundant drive system are obtained.
